(19) United States
(12) Patent Application Publication
(10) Pub. No.: US 2008/0262795 A1
(43) Pub. Date: Oct. 23, 2008

(54) Process Equipment Monitoring

(75) Inventors: Marcus Webb, Poway, CA (US); Soumitra Mishra, San Diego, CA (US)

Correspondence Address: STERNE, KESSLER, GOLDSTEIN & FOX, P.L.L.C., 1100 NEW YORK AVE., N.W., WASHINGTON, DC, 20005, US

(73) Assignee: Biogen Idec MA Inc, Cambridge, MA (US)

(21) Appl. No.: 11/817,109

(22) PCT Filed: Feb. 23, 2006
(86) PCT No.: PCT/US06/06214

§ 371 Date: May 21, 2008

Related U.S. Application Data
(60) Provisional application No. 60/655,899, filed on Feb. 25, 2005.

(51) Int. Cl. G06F 19/00

(52) U.S. Cl. 702/184; 702/183

(57) ABSTRACT

A system and method for monitoring process equipment includes collecting information from the process equipment. The collected information is statistically analyzed. One or more signatures indicating the overall status or health of one or more pieces of equipment can be developed.

### CLAIM OF PRIORITY

This application claims priority to provisional U.S. Patent Application No. 60/655,899, filed Feb. 25, 2005, which is incorporated by reference in its entirety.

### TECHNICAL FIELD

This invention relates to a method and system for monitoring the operational health and effectiveness of process equipment.

### BACKGROUND

The manufacture of products such as pharmaceuticals and biologics is highly regulated. Both the production process and the end product must be carefully monitored for adherence to standards and regulations. Variations from the prescribed production method, for example due to equipment failure, can require additional testing to be performed or even the disposal of the product, which can be costly. In any production facility, continuity of operations can be important for efficient production. Maintaining production facilities in operation and operating within specifications can therefore be an important goal in manufacturing.

A typical process unit (such as a bioreactor) is surrounded by instrumentation devices and sub-process units designed to allow the process unit to fulfill its intended purpose. The main objective of these ancillary devices is to provide measurement and control functions over the main process variables associated with the specific process unit. Traditional wiring of these devices employs two or four wires to allow the measurement and control functions to take place. This wiring scheme can transmit power and an analog 4-20 mA signal, or a discrete on-off signal. Detection of any failures, measurement errors, or control issues is typically performed on the equipment after a process issue has occurred and is performed by operations, maintenance or engineering personnel.

The use of industrial communication protocols, such as HART™, and more recently, the introduction of digital communication-based bus systems, such as FOUNDATION™ Fieldbus, Devicenet, and Profibus, has provided process instrumentation and ancillary equipment the ability to transmit a vast amount of information beyond the normal measurement or control signal. Using these communication protocols, the equipment can concurrently transmit a wealth of diagnostic information. Depending on the type of equipment, the diagnostic information can include, for example, calibration error, high temperature error, line failure, memory failure, glass failure, reference failure, low temperature error, sensor failure, CPU failure, input warning, glass impedance, reference impedance, RTD resistance, valve stem travel, or pump vibration information.

### SUMMARY

In an industrial manufacturing setting, proper timing of equipment maintenance can be important for operations. Frequent preventative maintenance can be costly, but an equipment failure during operations can require operations to be halted while unscheduled maintenance occurs, which can be even more costly. Statistical analysis of diagnostic information collected from process equipment can produce a signature that indicates the overall condition or health of a variety of equipment. Multiple signatures can be prepared for different pieces of equipment, or groups of equipment. These signatures can be unitless signatures and can be considered a process unit health monitor. The signature can represent equipment belonging to a particular component of an instrument, an instrument, a process subsystem, process unit, manufacturing line, or manufacturing facility. A user or operator can use a signature to quickly and conveniently determine whether equipment associated with a particular signature is functioning normally. If the signature (or signatures) shows a deviation from normal operations, the piece of equipment that is not functioning normally can be readily identified. When troubleshooting a product batch that may be out of specification, the process unit health signature (or signatures) can provide a quick way to eliminate the process equipment as a source of the issue affecting the batch. By helping an operator easily determine whether equipment is functioning normally, a signature can facilitate compliance with quality control or regulatory demands. This business method can be completed in a closed loop feedback method by providing automatic notification when a process unit health signature deviates from the normal operation signature trace.

In one aspect, a method of monitoring the operational status of equipment includes transmitting a first signal from a first sub-process unit to a control unit, transmitting a second signal from a second sub-process unit to the control unit, and calculating a signature based on the first signal and the second signal. The first signal is indicative of an operational status of the first process unit, and the second signal is indicative of an operational status of the second process unit.

The signature can be graphically displayed. Maintenance of the first sub-process unit or second sub-process unit can be scheduled based on the signature. Transmitting the first signal can include transmitting a digital signal. Transmitting the first signal can include transmitting via an industrial communication protocol. The signature can be a statistical measure. The statistical measure can include a T² or squared prediction error (SPE) statistic. The statistical measure can be a unitless measure. The signature can be based on multiple signals, for example, ten or more signals, twenty or more signals, or fifty or more signals.

A signature can be indicative of an operational status of a single sub-process unit or a plurality of sub-process units. A user can be notified when a signature, or a plurality of signatures, exceeds a predetermined threshold.

In another aspect, a method of monitoring the operational status of equipment includes transmitting a first plurality of signals from a first plurality of sub-process units to a control unit, and calculating a first signature based on the first plurality of signals. At least one signal of the first plurality is indicative of an operational status of at least one sub-process unit of the first plurality.

Each of the first plurality of signals can be indicative of an operational status of a sub-process unit of the first plurality. The method can include transmitting a second plurality of signals from a second plurality of sub-process units to a control unit, and calculating a second signature based on the second plurality of signals. At least one signal of the second plurality is indicative of an operational status of at least one sub-process unit of the second plurality. Each of the second plurality of signals can be indicative of an operational status of a sub-process unit of the second plurality. A third signature can be calculated based on the first plurality of signals and the second plurality of signals.

In another aspect, a system for monitoring the operational status of equipment includes a first sub-process unit configured to send a first signal to a control unit, and a second sub-process unit configured to send a second signal to the control unit. The first signal is indicative of an operational status of the first sub-process unit and the second signal is indicative of an operational status of the second sub-process unit. The control unit is configured to calculate a signature based on the first signal and the second signal.

The control unit can be further configured to graphically display the signature. The first signal can be a digital signal. The first process unit can be configured to send the first signal via an industrial communication protocol.

In another aspect, a system for monitoring the operational status of equipment includes a first plurality sub-process units, each being configured to send a signal to a control unit. At least one signal is indicative of an operational status of a sub-process unit of the first plurality. The control unit is configured to calculate a signature based on the plurality of signals sent from the first plurality of sub-process units.

Each sub-process unit of the first plurality can be configured to send a signal indicative of its operational status to the control unit. The system can include second plurality sub-process units, each being configured to send a signal to a control unit. At least one signal is indicative of an operational status of a sub-process unit of the second plurality. The control unit is configured to calculate a signature based on the plurality of signals sent from the second plurality of sub-process units. Each sub-process unit of the second plurality can be configured to send a signal indicative of its operational status to the control unit. The control unit can be configured to calculate a third signature based on the plurality of signals sent from the first plurality of sub-process units and the second plurality of sub-process units.

In another aspect, a method of monitoring a process includes calculating a signature indicative of an operational status of a plurality of sub-process units during a process operation, measuring a property of a product produced by the process, and determining whether the sub-process units were operating normally during the process operation.

Calculating the signature can include transmitting a first signal from a first sub-process unit to a control unit, and transmitting a second signal from a second sub-process unit to the control unit. The first signal is indicative of an operational status of the first process unit, and the second signal is indicative of an operational status of the second process unit. The method can include storing the signature, or storing a plurality of signatures.

In another aspect, a method of monitoring the operational status of equipment includes calculating a first signature indicative of an operational status of a first plurality of sub-process units, and calculating a second signature indicative of an operational status of a second plurality of sub-process units.

The first signature and the second signature can be graphically displayed. Maintenance of a sub-process unit of the first plurality can be scheduled based on the first signature.

In another aspect, a method of manufacturing a product includes manufacturing the product using a first sub-process unit and a second sub-process unit, transmitting a first signal from the first sub-process unit to a control unit, transmitting a second signal from the second sub-process unit to the control unit, and calculating a signature based on the first signal and the second signal. The first signal is indicative of an operational status of the first process unit, and the second signal is indicative of an operational status of the second process unit. The method can include assigning a product quality rating based on the signature, or a plurality of signatures. The method can include determining whether a single processing unit or multiple processing units are suitable for subsequent processing, for example, to establish availability for use.

The details of one or more embodiments are set forth in the accompanying drawings and the description below. Other features, objects, and advantages will be apparent from the description and drawings, and from the claims.

### BRIEF DESCRIPTION OF DRAWINGS

FIG. 1 is a schematic depiction of a bioreactor.

FIGS. 2A and 2B are graphs depicting exemplary process control data.

FIGS. 3A and 3B are photographs illustrating a digital bus system wiring applied in a process plant.

FIGS. 4A and 4B are screen captures depicting diagnostic information available through a digital bus system.

FIGS. 5A and 5B are graphs depicting multivariate statistical process control (MSPC) unitless signatures.

### DETAILED DESCRIPTION

A process refers to any industrial method by which a product is made. Many industries use some form of process control to ensure that the process operates according to a predetermined specification. In general, process control requires a feedback loop. A measurement of some property of the process is taken and compared to a setpoint value. An output is generated depending on the results of the comparison. The output is designed to adjust the measured property towards the setpoint. The process control is typically automated. The measurement, comparison, and output are performed automatically. A user can pre-configure the process control equipment with respect to, for example, the setpoints and controller sensitivity. A proportional-integral-derivative (PID) controller is one example of a controller that can be used for process control.

In many cases, the industrial process requires a number of properties to be controlled for optimum performance of the process. Some examples of properties that can be controlled (also referred to as process variables) are temperature, pH, pressure, flow velocity, mixing rate, concentration of gases, liquids, or solids, and electrical properties such as conductivity or resistivity. Sometimes, adjusting one process variable influences another process variable. When this is the case, it is said that the control loops are linked or coupled. It can be difficult to determine how (or if) two or more control loops are coupled. Some processes can be very complex, requiring a large number of process steps and having many variables that require control. A complex process can also require the operation of a great deal of equipment, such as valves, pumps, heating and cooling equipment, mixers, flow controllers, sensors, and the like, all of which equipment must be maintained in good working order.

A system and method for monitoring the status of process equipment can be useful in any industry where process equipment is used, especially where equipment failures reduce product yield or quality. In particular, the system and method can be used advantageously where a high-value product, or a complex-to-manufacture product, that requires many manufacturing steps be carried out according to precise specifications and time constraints. Some examples of industrial equipment, processes, or unit procedures (a unit procedure is typically defined as a sequence of actions, or operations, taking place within the same main piece(s) of equipment) where the system and method can be used include a vessel procedure, such as a process carried out in a stirred tank reactor, a seed reactor, a stirred tank fermentor, a seed fermentor, an air-lift fermentor, a continuous stirred tank reactor, or a plug flow reactor.

Other process amenable to use with the system and method include: aerobic bio-oxidation (e.g., environmental well mixed, or plug flow oxidations), anaerobic digestion, trickling filtration, anoxic reaction, neutralization, wet air oxidation, and incineration.

The system and method can be used with a filtration process, for example, a microfiltration, an ultrafiltration, or a reverse osmosis process, any of which can be in a batch or continuous (feed-and-bleed)) format. Other filtrations include diafiltration, dead-end, Nutsche, plate & frame, rotary vacuum, air filtration, belt filter press, granular multi-medium, and baghouse filtrations.

Additional processes include electrostatic precipitation, gas cyclone, hydrocyclone, homogenization, bead milling, and centrifugation. Centrifugation can be carried out with a decanter centrifuge, a disk-stack centrifuge, a bowl centrifuge, a basket centrifuge (top discharge or bottom discharge), and a centritech centrifuge. Chromatographic process, such as gel filtration (size exclusion chromatography), adsorptive chromatography in a packed bed or expanded bed column (e.g., ion exchange, affinity, HIC, reverse phase, etc.), ion exchange, mixed-bed ion exchange, and GAC adsorption (for liquid and gaseous streams).

Equipment for drying, for example, a tray dryer, freeze drying (lyophilization) equipment, a double cone dryer, a sphere dryer, a cone screw dryer, a spray dryer, a fluid bed dryer, a drum dryer, a rotary dryer, or a generic sludge dryer can be monitored with the system and method. So can separation equipment, such as equipment for sedimentation (separation of two immiscible liquid phases in a decanter tank), clarification (removal of particulate components in a clarifier), an inclined plate separator, a thickener basin, a dissolved-air flotation tank, or an API oil separator.

Distillation and fractionation (e.g., flash, batch, or continuous), extraction (e.g., mixer-settler extractor, differential (column) extractor, or centrifugal extractor), phase change (e.g., condensation, single- and multiple-effect continuous evaporation, thin film evaporation, crystallization under continuous flow), absorption/adsorption, stripping, and degasification equipment can all be used with the system and method. Likewise, process equipment for storage, (such as, for example, batch and continuous storage in a blending tank, a flat bottom tank, a receiver tank, a horizontal tank, a vertical-on-legs tank, a horizontal tank on wheels, a horizontal tank with mixer, a silo, or a hopper) are suitable for use with the system and method. Other types of equipment can include equalization equipment, a junction box mixer, a heat exchanger or cooling tower, a heat sterilizer, mixing equipment (e.g., bulk flow, mixture preparation, tumble mixer, or discrete flow), splitting equipment (e.g., for bulk flow, multi-way flow distribution, discrete flow, or on a component-by-component basis), and size reduction equipment (for example, bulk or discrete grinding or shredding).

Equipment for formulation and packaging of products (e.g., for extrusion, blow molding, injection molding, trimming, filling, assembly, printing, label attachment, or packing), or for tableting can be monitored by the system and method. Process equipment that is used for transport of products or materials can be monitored as well. Examples of transport equipment include a centrifugal pump, a gear pump, a diaphragm pump, a centrifugal compressor, a centrifugal fan, a belt conveyor (bulk), a belt conveyor (discrete), a pneumatic conveyor (bulk), a pneumatic conveyor (discrete), a screw conveyor (bulk), a screw conveyor (discrete), a bucket elevator (bulk), and a bucket elevator (discrete). Valves can also be monitored, for example, a gate valve, a control globe valve, or a butterfly valve.

As one example, petroleum refining begins with the distillation, or fractionation, of crude oils into separate hydrocarbon groups. The resultant products are directly related to the characteristics of the crude processed. Most distillation products are further converted into more usable products by changing the size and structure of the hydrocarbon molecules through cracking, reforming, and other conversion processes. These converted products are then subjected to various treatment and separation processes such as extraction, hydrotreating, and sweetening to remove undesirable constituents and improve product quality. Integrated refineries incorporate fractionation, conversion, treatment, and blending operations and may also include petrochemical processing.

Auxiliary operations for a refinery can include: steam and power generation; process and fire water systems; flares and relief systems; furnaces and heaters; pumps and valves; supply of steam, air, nitrogen, and other plant gases; alarms and sensors; noise and pollution controls; sampling, testing, and inspecting. The operation of the refinery requires a substantial amount of equipment for temperature control, flow control, product analysis, and so on. A system that monitors the status the auxiliary equipment can help an operator quickly identify any equipment problems that might interfere with refinery operations.

As another example, fermentation is a complex process. Typically a fermentation is carried out in a bioreactor. In general, a bioreactor is a device for culturing living cells. The cells can produce a desired product, such as, for example, a protein, or a metabolite. The protein can be, for example a therapeutic protein, for example a protein that recognizes a desired target. The protein can be an antibody. The metabolite can be a substance produced by metabolic action of the cells, for example, a small molecule. A small molecule can have a molecular weight of less than 5,000 Da, or less than 1,000 Da. The metabolite can be, for example, a mono- or poly-saccharide, a lipid, a nucleic acid or nucleotide, a peptide (e.g., a small protein), a toxin, or an antibiotic.

The bioreactor can be, for example, a stirred-tank bioreactor. The bioreactor can include a tank holding a liquid medium in which living cells are suspended. The tank can include ports for adding or removing medium, adding gas or liquid to the tank (for example, to supply air to the tank, or adjust the pH of the medium with an acidic or basic solution), and ports that allow sensors to sample the space inside the tank. The sensors can measure conditions inside the bioreactor, such as, for example, temperature, pH, or dissolved oxygen concentration. The ports can be configured to maintain sterile conditions within the tank. Other bioreactor designs are known in the art. The bioreactor can be used for culturing eukaryotic cells, such as a yeast, insect, plant or animal cells; or for culturing prokaryotic cells, such as bacteria. Animal cells can include mammalian cells, an example of which is Chinese hamster ovary (CHO) cells. In some circumstances, the bioreactor can have a support for cell attachment, for example when the cells to be cultured grow best when attached to a support. The tank can have a wide range of volume capacity—from 1 L or less to 20,000 L or more. For example, a bioreactor train can have tank capacities of 50 L, 150 L, 750 L, 3,750 L, or 20,000 L. In a manufacturing context, a cell culture can be transferred to a bioreactor with a larger tank size in order to increase the volume of the cell culture. The cell culture can be increased in volume according to a predetermined ratio at each step. For example, a culture of CHO cells can be transferred to a bioreactor that has a volume five times larger. Other ratios can apply to other CHO cell processes or types of cells.

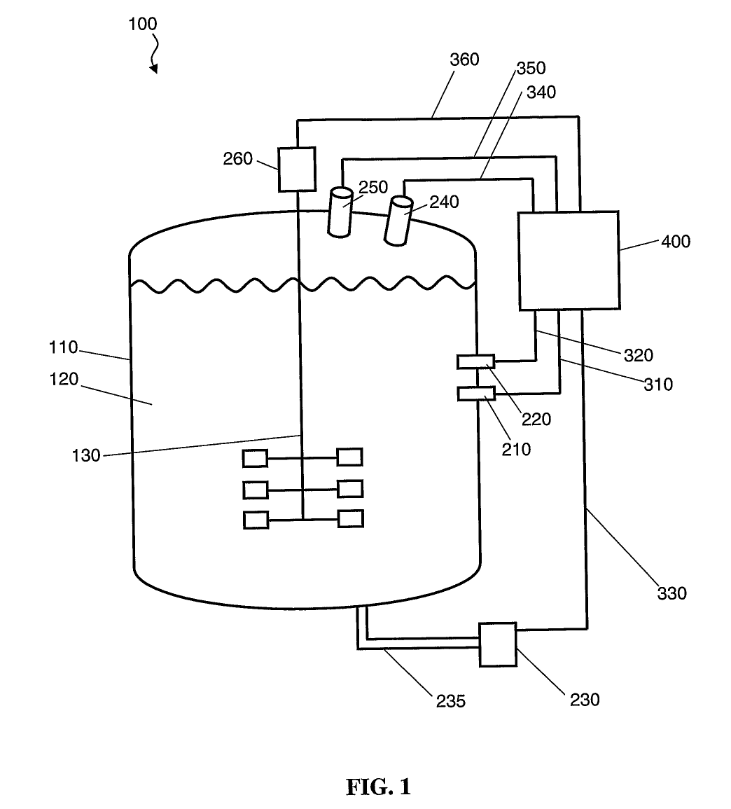

Referring to FIG. 1, process unit 100 is demonstrated as a liquid reactor, such as a bioreactor. Process unit 100 includes vessel 110, holding liquid cell culture 120 which can be stirred by agitator 130. Process unit 100 further includes sub-process units 210, 220, 230, 240 and 250. For the purposes of exemplifying the variety of sub-process units that can be associated with process unit 100, sub-process unit 210 can be a pH meter; unit 220 an oxidation-reduction potential (ORP) meter; unit 230 a flow controller for gas supply 235; units 240 and 250 can be acid and base pumps; respectively, for pH control; and unit 260 can be a motor for agitator 230. Each sub-process unit 210, 220, 230, 240, 250 and 260 provides an input 310, 320, 330, 340, 350 and 360, respectively, to control system 400. Inputs 310, 320, 330, 340, 350 and 360 can include an analog signal, a digital signal, or both an analog and digital signal. In some embodiments, a digital signal provides a measure of a primary variable (such as pH or ORP), and the digital signal includes a measure of a secondary variable. The secondary variable can provide information about the operational status, diagnostics, or health of the unit. Sub-process units capable of reporting an operational status (using, for example, the HART or Fieldbus protocols) are available from, for example, ABB Automation Products GmbH, Emerson Process Management, Foxboro, and Yokogawa.

SPC can be applied in a univariate or multivariate method. One approach to controlling complex processes is the use of statistical process control (SPC). SPC involves using statistical techniques to measure and analyze the variation in processes, for example, in order to monitor product quality and maintain processes to fixed targets. The behavior of a process parameter can be analyzed statistically, determining a mean and standard deviation for the parameter. The standard deviation can be used to help set or adjust upper and lower setpoints for the parameter.

More than one process parameter can be subjected to statistical analysis using multivariate SPC (MSPC). MSPC can use multivariate statistical models of individual or groups of operations to determine whether process operations or product quality are within specifications. MSPC can be used for real-time monitoring of processes. MSPC software is available from, for example, Emerson Process Management or Umetrics.

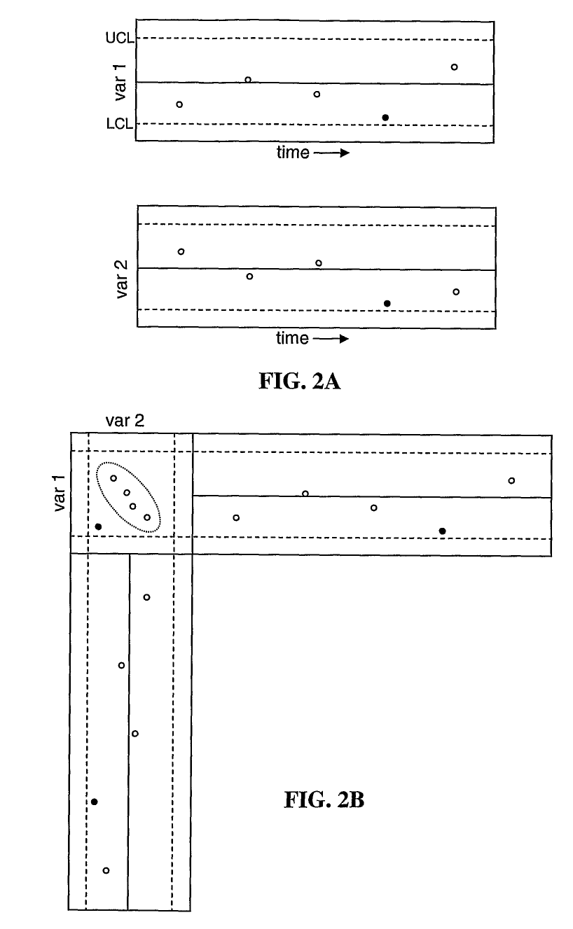

MSPC can provide advantages over other process control schemes, for example, when two or more process variables are correlated. FIG. 2 illustrates such a scenario. FIG. 2A shows the values of two variables (designated var 1 and var 2) plotted as a function of time. Each plot shows the setpoint value (solid line), upper control limit (UCL, dotted line) and lower control limit (LCL, dotted line) for the variable. In each univariate plot, all points fall within the control limits. From FIG. 2B it is apparent that the two variables are correlated when the process is in control. Four of the plotted values falling within the correlated control region (dotted ellipse). In this circumstance, when var 1 and var 2 fall within the ellipse, the process is in control, as shown by the open circles. The process can be out of control even when both var 1 and var 2 fall within their respective nominal control limits (filled circle). The control region can be calculated on a statistical basis, for example, as a selected number of standard deviations from the mean values of var 1 and var 2.

MSPC can use techniques such as principal component analysis (PCA), principal component regression (PCR), partial least squares (PLS), and canonical correlation analysis (CCA). Such techniques can reduce the dimensionality of a data set while retaining as much of the variation contained in the original data as possible.

MSPC is typically used in the optimization or control of a process. Measurements of process variables are provided to a computer running MSPC software. The software analyzes the process variable data. In a process control setting, the software can calculate and provide outputs to adjust the level of one or more process variables.

Control system 400 can include an MSPC system. The MSPC system can accept inputs 310, 320, 330, 340, 350 and 360 from sub-process units 210, 220, 230, 240, 250 and 260. The inputs can convey information about the operational status of the sub-process units. The inputs can include an analog or digital signal. The MSPC system can calculate one or more signatures based on the inputs. The signature can reflect the operation status of the entire process unit, or a selected set of sub-process units. Control system 400 can include a display screen to provide a graphical view of the signature to an operator or user.

The sub-process units can provide data to MSPC software for process control purposes. For example, a pH meter can be used for measuring pH in a process control context. As discussed above, many sub-process units are now available that can deliver multiple signals related to its status (i.e., diagnostic signals). The measurement signal and diagnostic signals can be transmitted as a digital signal. For example, the pH meter can use a digital communication protocol to transmit one or more diagnostic variables to a control system, in addition to the pH measurement. The diagnostic variable can be, for example, glass impedance, reference impendence or resistance temperature detector (RTD) resistance.

The diagnostic variable can be an input to an MSPC system. The MSPC system can accept input from multiple sub-process units. The input can provide information about the operational status of the sub-process unit.

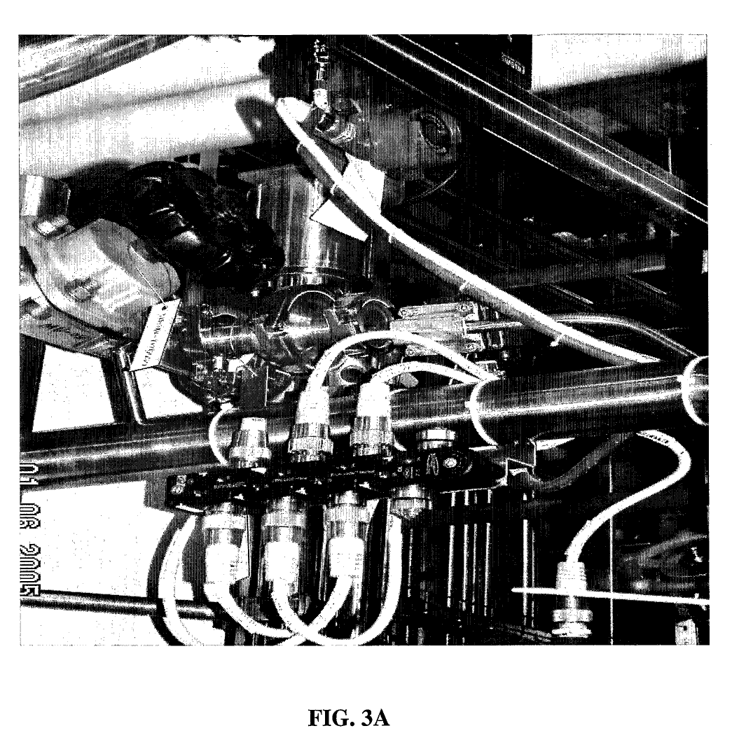

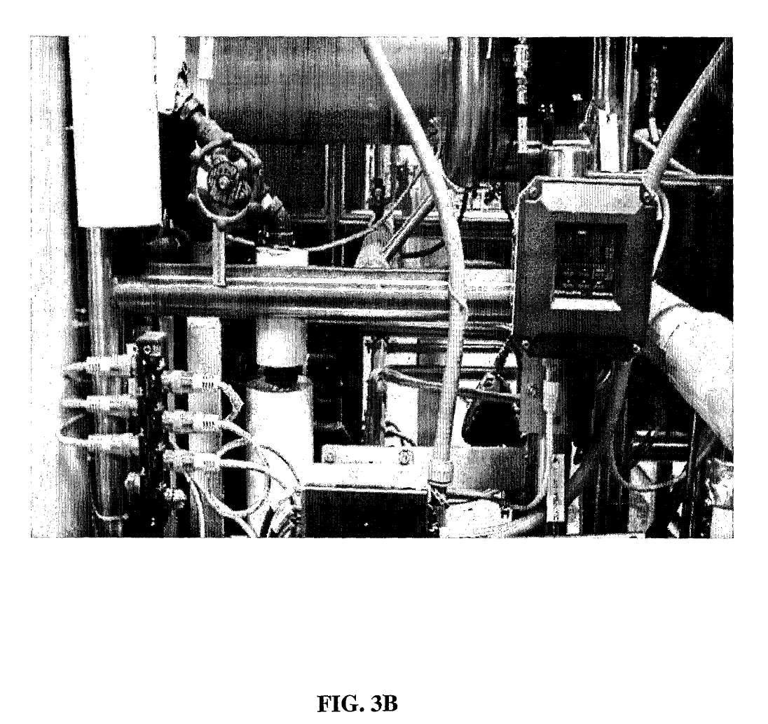

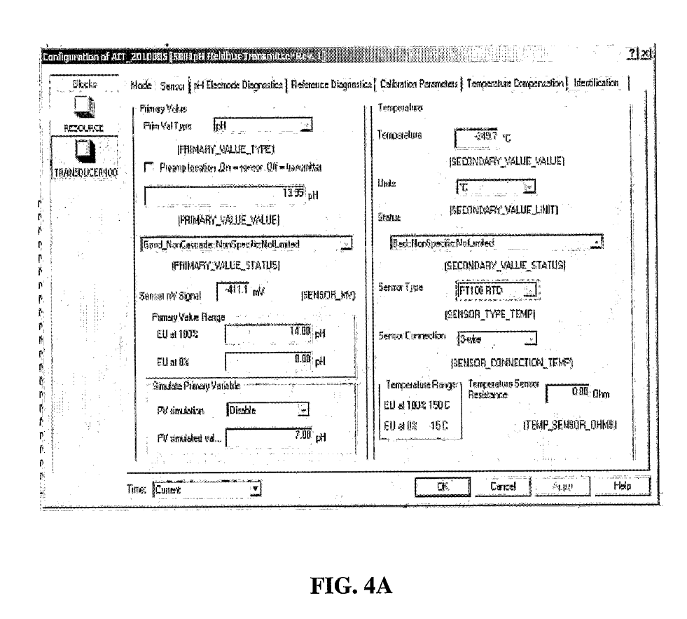

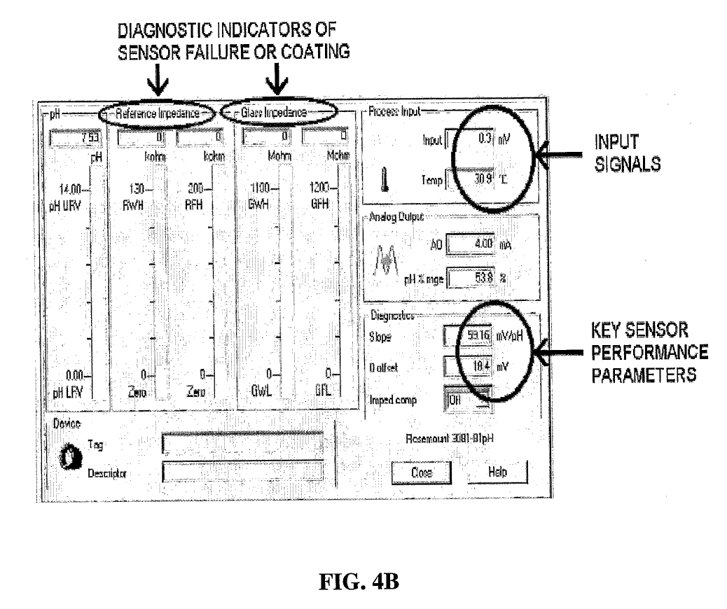

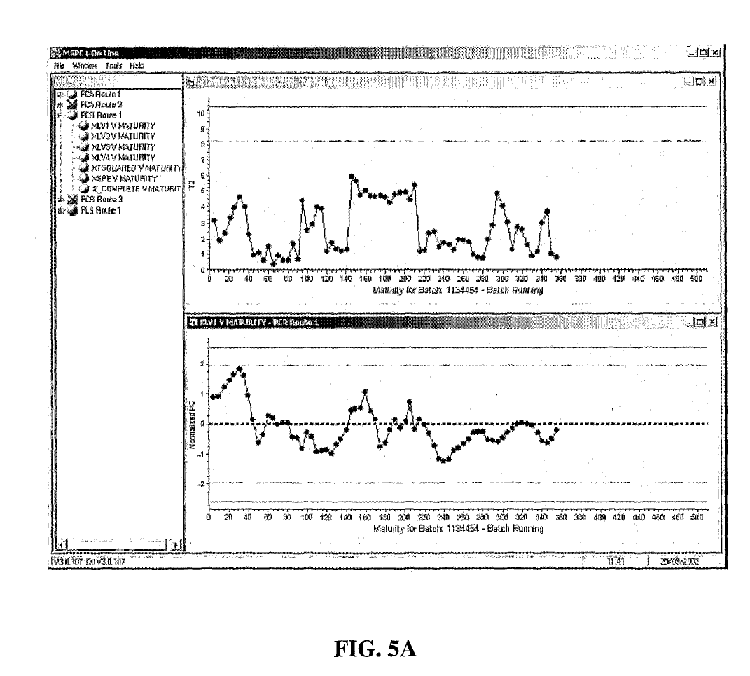

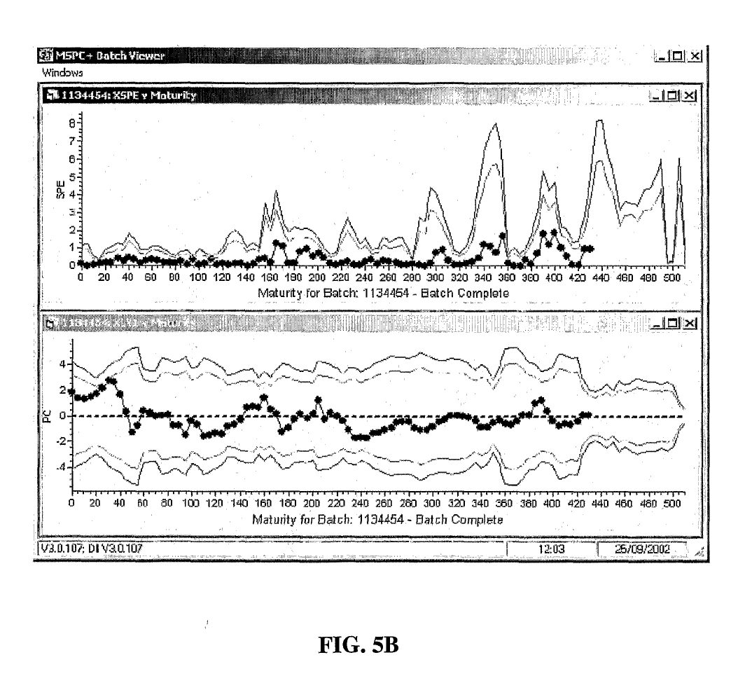

For example, referring to FIGS. 3A and 3B, a digital bus system wiring (yellow cable) application in a process plant can utilize a trunk and spur connection arrangement. The main communication trunk enters the black “brick.” Spurs then emanate out from this brick to local field instrumentation devices. Referring to FIGS. 4A and 4B, a screen can display diagnostic information available through a digital bus system. In this example, the digital bus system is able to transmit not only the main process value of pH and the secondary process value of temperature, but also additional key sensor performance information such as pH electrode diagnostics, reference diagnostics, and calibration parameters. Referring to FIGS. 5A and 5B multivariate statistical process control (MSPC) signatures can be displayed graphically. In this example a number of inputs (e.g., XLV1V MATURITY, XLV2V MATURITY, XLV3V MATURITY, XLV4V MATURITY) are used to create and plot a number of multivariate analytical traces, for example, T², normalized PC, SPE and PC versus batch maturity. Each trace has a y-axis that is essentially unitless and is a statistical composite of the contribution of each input variable.

MSPC methods can be used to provide a signature, or signatures, for the inputs to the MSPC analysis. The signature can be a variable that changes as a function of time. Each signature can be associated with one or more threshold values. When a signature exceeds a threshold (i.e., is greater than an upper threshold or less than a lower threshold), it can be an indication of abnormal operation. A signature built on multivariate SPC techniques can detect abnormal operations with greater sensitivity than univariate SPC monitoring. Each signature can be displayed graphically. A signature can be, for example, a T² statistic or SPE statistic. Use of a T² statistic in MSPC is described in, for example, Multivariate Statistical Process Control with Industrial Application by Robert Lee Mason, and John C. Young, Society for Industrial and Applied Mathematics, 2001, which is incorporated by reference in its entirety. Each signature can include more than one variable. For example, a signature can be displayed as a graph showing a first principal component (as determined by PCA) on one axis and a second principal component on another axis, or a T² or SPE chart.

One or more signatures can be developed for each process unit or sub-process unit. The signatures can be displayed one at a time, in groups, or all at once on a graphic screen (e.g., a computer display). Two or more groups of equipment each having its own signature, or signatures, can be monitored by a single composite signature. The composite signature can indicate the status of, for example, a manufacturing line, the equipment in one area or floor of a plant.

Multiple signals can contribute to a signature. For example, a signature can be calculated based on 1, 2 or more, 5 or more, 10 or more, 20 or more, or 30 more signals. A single input can contribute to more than one signature. When a large number of signals (e.g., 30 or more) is available for a process unit, a smaller number of signatures can be generated, helping to simplify monitoring of the equipment for an operator. Expressed mathematically, a matrix N×P (representing variables×observations) can be transformed into a matrix K×P where K<<N, and K represents the calculated signatures.

A master health indicator graphic screen can show all the signatures for a process unit, a manufacturing system or line, or an entire facility. Manufacturing, engineering and maintenance personnel can quickly and conveniently refer to this display to survey the facility to make sure that all equipment is working as intended. Each signature can be calculated and displayed in real time.

The signature (or signatures) can also be stored for future reference and record-keeping purposes. A record of each signature can be stored, for example, on paper records, or on a machine-readable medium (e.g., floppy disk, hard disk drive, CD-ROM, or the like). The stored signature can be associated with a product. For example, a RFID tag can be physically associated with a product, and information relating to the manufacture of the product (e.g., a signature) can be stored in a memory on the RFID tag. See, for example, U.S. Pat. No. 6,839,604, which is incorporated by reference in its entirety.

Traditionally, preventative equipment maintenance is performed on a time based interval. For example, it may be known that a particular piece of equipment is reliable for a period of time, and if allowed to operate for a longer period of time, can fail unpredictably. To prevent equipment failure during operations, that piece of equipment would be serviced or replaced before the end of the period of reliability.

Changes in the level of a signature can prompt preventative maintenance activities. For example, the signature can be sensitive to deterioration in equipment operation that occurs prior to equipment failure. When the MSPC system detects such a change, it can alert maintenance personnel, in order to schedule maintenance at a convenient time, such as between batches. The alert can be a visual message on a display screen, a page sent to an operator's pager, an email, or another electronic communication, or a combination. The MSPC system can be configured to interact with other software, for example to generate a work order for equipment determined to be faulty based on a signature or signatures.

Maintenance activities can thus be delayed until the equipment requires attention, avoiding waste. At the same time, maintenance can be performed before equipment failure, which can disrupt operations. For example, detectable conditions that can prompt maintenance activities include measurement sensor drift, liquid leak, valve problems, head loss, unsteady process, or pump problems.

When troubleshooting a batch that may be out of specification, the process unit health signatures can provide a quick way to eliminate the process equipment as a source of the issue affecting the batch.

A number of embodiments have been described. Nevertheless, it will be understood that various modifications may be made. Accordingly, other embodiments are within the scope of the following claims.

1. A method of monitoring the operational status of equipment comprising: transmitting a first signal from a first sub-process unit to a control unit, wherein the first signal is indicative of an operational status of the first sub-process unit; transmitting a second signal from a second sub-process unit to the control unit, wherein the second signal is indicative of an operational status of the second sub-process unit; and calculating a signature based on the first signal and the second signal.

2. The method of claim 1, further comprising graphically displaying the signature.

3. The method of claim 1, further comprising scheduling maintenance of the first sub-process unit or second sub-process unit based on the signature.

4. The method of claim 1, wherein transmitting the first signal includes transmitting a digital signal.

5. The method of claim 1, wherein transmitting the first signal includes transmitting via an industrial communication protocol.

6. The method of claim 1, wherein the signature is indicative of an operational status of a plurality of sub-process units.

7. The method of claim 1, wherein the signature is a statistical measure.

8. The method of claim 7, wherein the statistical measure includes a T² or SPE statistic.

9. The method of claim 7, wherein the statistical measure is a unitless measure.

10. The method of claim 1, wherein the signature is based on ten or more signals.

11. The method of claim 1, wherein the signature is based on fifty or more signals.

12. The method of claim 1, further comprising notifying a user when the signature exceeds a predetermined threshold.

13. A method of monitoring the operational status of equipment comprising: transmitting a first plurality of signals from a first plurality of sub-process units to a control unit, wherein at least one signal of the first plurality is indicative of an operational status of at least one sub-process unit of the first plurality; and calculating a first signature based on the first plurality of signals.

14. The method of claim 13, wherein each of the first plurality of signals is indicative of an operational status of a sub-process unit of the first plurality.

15. The method of claim 13, further comprising transmitting a second plurality of signals from a second plurality of sub-process units to a control unit, wherein at least one signal of the second plurality is indicative of an operational status of at least one sub-process unit of the second plurality; and calculating a second signature based on the second plurality of signals.

16. The method of claim 15, wherein each of the second plurality of signals is indicative of an operational status of a sub-process unit of the second plurality.

17. The method of claim 15, further comprising calculating a third signature based on the first plurality of signals and the second plurality of signals.

18. A system for monitoring the operational status of equipment comprising: a first sub-process unit configured to send a first signal to a control unit; wherein the first signal is indicative of an operational status of the first sub-process unit; and a second sub-process unit configured to send a second signal to the control unit; wherein the second signal is indicative of an operational status of the second sub-process unit; wherein the control unit is configured to calculate a signature based on the first signal and the second signal.

19. The system of claim 18, wherein the control unit is further configured to graphically display the signature.

20. The system of claim 18, wherein the first signal is a digital signal.

21. The system of claim 18, wherein the first sub-process unit is configured to send the first signal via an industrial communication protocol.

22. The system of claim 18, wherein the signature is indicative of an operational status of a plurality of sub-process units.

23. The system of claim 18, wherein the signature is a statistical measure.

24. The system of claim 23, wherein the statistical measure includes a T² or SPE statistic.

25. A system for monitoring the operational status of equipment comprising: a first plurality sub-process units, each being configured to send a signal to a control unit; wherein at least one signal is indicative of an operational status of a sub-process unit of the first plurality; wherein the control unit is configured to calculate a signature based on the plurality of signals sent from the first plurality of sub-process units.

26. The system of claim 25, wherein each sub-process unit of the first plurality is configured to send a signal indicative of its operational status to the control unit.

27. The system of claim 25, further comprising a second plurality sub-process units, each being configured to send a signal to a control unit; wherein at least one signal is indicative of an operational status of a sub-process unit of the second plurality; wherein the control unit is configured to calculate a signature based on the plurality of signals sent from the second plurality of sub-process units.

28. The system of claim 27, wherein each sub-process unit of the second plurality is configured to send a signal indicative of its operational status to the control unit.

29. The system of claim 28, wherein the control unit is configured to calculate a third signature based on the plurality of signals sent from the first plurality of sub-process units and the second plurality of sub-process units.

30. A method of monitoring a process comprising: calculating a signature indicative of an operational status of a plurality of sub-process units during a process operation; measuring a property of a product produced by the process; and determining whether the sub-process units were operating normally during the process operation.

31. The method of claim 30, wherein calculating the signature includes transmitting a first signal from a first sub-process unit to a control unit, wherein the first signal is indicative of an operational status of the first sub-process unit; and transmitting a second signal from a second sub-process unit to the control unit, wherein the second signal is indicative of an operational status of the second sub-process unit.

32. The method of claim 30, further comprising storing the signature.

33. The method of claim 30, further comprising scheduling maintenance of a sub-process unit of the plurality based on the signature.

34. The method of claim 30, wherein the signature is a statistical measure.

35. The method of claim 34, wherein the statistical measure includes a T² or SPE statistic.

36. A method of monitoring the operational status of equipment comprising: calculating a first signature indicative of an operational status of a first plurality of sub-process units; and calculating a second signature indicative of an operational status of a second plurality of sub-process units.

37. The method of claim 36, further comprising graphically displaying the first signature and the second signature.

38. The method of claim 36, further comprising scheduling maintenance of a sub-process unit of the first plurality based on the first signature.

39. A method of manufacturing a product comprising: manufacturing the product using a first sub-process unit and a second sub-process unit; transmitting a first signal from the first sub-process unit to a control unit, wherein the first signal is indicative of an operational status of the first sub-process unit; transmitting a second signal from the second sub-process unit to the control unit, wherein the second signal is indicative of an operational status of the second sub-process unit; and calculating a signature based on the first signal and the second signal.

40. The method of claim 39, further comprising assigning a product quality rating based on the signature.

41. The method of any one of claims 1 to 24 or 36 to 38, wherein said equipment comprises a bioreactor.

42. The system of any one of claims 25 to 29, wherein said equipment comprises a bioreactor.

43. The method of any one of claims 30 to 35, wherein said process comprises culturing living cells.

44. The method of any one of claims 39 or 40, wherein said product is produced by living cells.
